(19) United States
(12) Patent Application Publication
(10) Pub. No.: US 2015/0043722 A1
(43) Pub. Date: Feb. 12, 2015

(54) COMMUNICATION CONTROL DEVICE, COMMUNICATION CONTROL METHOD, AND COMMUNICATION CONTROL SYSTEM

(71) Applicant: FUJITSU LIMITED, Kawasaki-shi (JP)

(72) Inventors: Hidehiko Fujimoto, Fukuoka (JP); Naotaka TSUJI, Fukuoka (JP); Kusuo YONEZAWA, Fukuoka (JP); Yuichi HARAGUCHI, Fukuoka (JP)

(21) Appl. No.: 14/332,048

(22) Filed: Jul. 15, 2014

(30) Foreign Application Priority Data
Aug. 12, 2013 (JP) 2013-167671

(51) Int. Cl. H04M 3/22; H04M 3/24

(52) U.S. Cl. CPC H04M 3/2263; H04M 3/24
USPC 379/112.04

(57) ABSTRACT

A call connection number management unit acquires the number of call connections. A server suspension control unit transfers a calling process allocated to a call control server selected based on the number of call connections for each of call control servers to the call control server, and suspends the call control server when the calling process allocated to the call control server ceases. An assignment control unit assigns a request to the call control server to which the calling process responding to the request has been transferred, when the call control server that has performed the calling process responding to the request is suspended. A prediction activation control unit calculates a change rate of an increase rate of the number of calls, obtains a prediction value of the number of calls based on the change rate, and when the prediction value exceeds a value, activates the suspended call control server.

### CROSS-REFERENCE TO RELATED APPLICATION

This application is based upon and claims the benefit of priority of the prior Japanese Patent Application No. 2013-167671, filed on Aug. 12, 2013, the entire contents of which are incorporated herein by reference.

### FIELD

The embodiment discussed herein is directed to a communication control device, a communication control method, and a communication control system.

### BACKGROUND

In recent years, the traffic volume has been increasing in the field of communication services due to the increases in the number of users of broadband connection services and the diversity of services. In view of such trends, it is preferable that servers used in the field of communication have performance that can deal with a future traffic volume.

In realizing the performance that can deal with a future traffic volume, a method of increasing the capacity per server has a limit in the performance for response. Moreover, the effective utilization of the facility and the countermeasure for the lower power consumption for the stepwise traffic fluctuation from the small start have recently been anticipated. Under such circumstances, the requirements for the server have been difficult to be unsatisfied just by the conventional ACT/SBY (Active/Standby) function or the duplex function. In view of this, realization of the improvement of the performance and the scale of the system by the use of the communication control system based on a plurality of servers has been proposed.

Then, in the case of using the plurality of servers, it can be considered to reduce the number of operating servers for the countermeasure for the lower power consumption; however, when the timing of activating the suspended server is delayed due to the increase in process, the upper limit value of the process of the operating servers may be exceeded. When the upper limit value of the process of the servers is exceeded as described above, a call loss may occur in the communication control system.

In view of this, various techniques have been proposed in order to deal with the increase in process in such a state that the number of information processing devices operating in a system having a plurality of information processing devices is reduced. For example, there is a conventional technique in which when a task can be processed in one CPU core in a multi-core system, the other is suspended, and when an increase rate of an activity ratio is higher than a threshold, the increase in a load is predicted, and then the activation of the other CPU is prepared.

Further, there is a conventional technique in which the increase in a process load of the information processing device is predicted by determining that the load is high when an increase rate of a current process volume has become less than or equal to a predetermined value.

Further, there is a conventional technique in which the threshold is increased when the number of times when the packet volume between a transmitter and a receiver becomes the threshold or more has become a reference value or more.

Patent Literature 1: International Publication Pamphlet No. WO 2010/010723

Patent Literature 2: Japanese Laid-open Patent Publication No. 2008-158996

Patent Literature 3: Japanese Laid-open Patent Publication No. 2009-81629

In any of the above conventional techniques, however, the change in a load is predicted by using a current increase rate, and the change in an increase rate itself is not considered. Therefore, the change in a load can be predicted as long as the increase rate is constant; however, when the increase rate has changed, it is difficult to predict the change in a load with high accuracy. Then, since the change in the number of calls is not constant but largely varies in the communication control system, it is difficult to avoid the occurrence of the call loss associated with the increase in process in any of the above conventional techniques.

### SUMMARY

According to an aspect of an embodiment, a communication control device includes: a call connection number management unit that acquires a call connection number representing a number of calls being processed by each call control server performing a calling process; a server suspension control unit that selects a first call control server from the call control servers based on the call connection number for each of the call control servers, transfers the calling process allocated to the first call control server to other call control server, and suspends the first call control server when the calling process allocated to the first call control server no longer exists; an assignment control unit that accepts a process request related to the calling process, and when the call control server that has performed the calling process responding to the process request is suspended by the server suspension control unit, assigns the process request to the other call control server to which the server suspension control unit has transferred the calling process responding to the process request; and a prediction activation control unit that calculates a change rate of an increase rate of number of calls to be processed by a particular call control server, obtains a prediction value of a number of calls to be processed by the particular call control server after a predetermined period of time on the basis of the change rate, and when the prediction value is exceeding a predetermined value, activates a suspended call control server.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a communication control system according to a first embodiment;

FIG. 2 is a diagram of an example of call information;

FIG. 3 is a diagram of an example of server management information;

FIG. 4 is a diagram of an example of a call connection information list;

FIG. 5 is a diagram of an example of a server status management table;

FIG. 6 is a diagram for describing calculation of call acceleration and the increase of the number of calls after the elapse of a server operation time;

FIG. 7 is a flowchart of a process of activation determination of the call control server using prediction of the increase in the number of calls by a communication control device according to the first embodiment;

FIG. 8 is a flowchart of a process of calculating outgoing call acceleration and communicating call acceleration;

FIG. 9 is a flowchart of a process of activation determination of the call control server by the communication control device according to the first embodiment;

FIG. 10 is a diagram illustrating an example of the transition of the number of calls in the case where one call control server is activated based on the prediction of the increase of the number of calls;

FIG. 11 is a diagram illustrating an example of the transition of the number of calls in the case where a plurality of call control servers is activated based on the prediction of the increase of the number of calls;

FIG. 12 is a diagram of a structure example in the case where a communication control device is structured by two servers;

FIG. 13 is a diagram representing an example of the relation between the change in the outgoing call acceleration and a constant monitor period;

FIG. 14 is a diagram representing an example of the relation between the number of connections and the monitor period;

FIG. 15 is a diagram representing an example of the relation between the change in the outgoing call acceleration and the change in the monitor period;

FIG. 16 is a flowchart of a process of activation determination of a call control server by a communication control device according to a second embodiment;

FIG. 17 is a diagram illustrating an example of the transition of the number of calls in the case where one call control server is activated based on outgoing call acceleration; and

FIG. 18 is a diagram illustrating an example of a hardware structure of a communication control device.

### DESCRIPTION OF EMBODIMENTS

Preferred embodiments of the present invention will be explained with reference to accompanying drawings. Note that the communication control device, the communication control method, and the communication control system disclosed in the present application are not limited by the embodiments

### First Embodiment

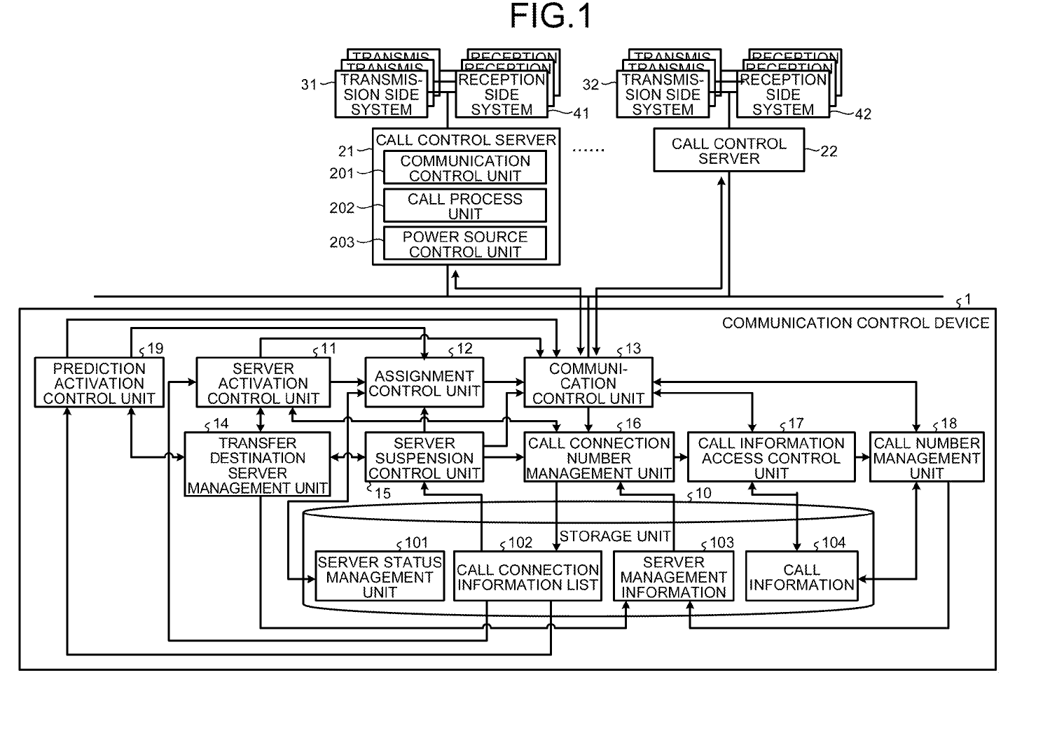

FIG. 1 is a block diagram of a communication control system according to a first embodiment. The communication control system according to this embodiment has a communication control device 1 and call control servers 21 to 22. Here, although FIG. 1 illustrates only two call control servers 21 and 22, the number of call control servers may be three or more. Hereinafter, the call control servers are referred to as a “call control server 20” unless the call control servers are distinguished. The communication control device 1 and the call control server 20 are connected to each other via a network.

Further, combination of a transmission side system 31 and a reception side system 41 represents that a calling process is being performed between the systems through the call control server 21. Moreover, the combination of a transmission side system 32 and a reception side system 42 represents that the calling process is being performed between the systems through the call control server 22. In order to represent the correspondence with the call control server that is managing the calling process, FIG. 1 illustrates that the call control servers 21 and 22 are connected with the transmission side systems 31 and 32 and the reception side systems 41 and 42, respectively. However, the transmission side systems 31 and 32 and the reception side systems 41 and 42 may be connected to the network that connects the communication control device 1 and the call control servers 21 to 22. In the description bellow the transmission side systems are referred to as a “transmission side system 30” unless the systems are distinguished. Further, the reception side systems are referred to as a “reception side system 40” unless the systems are distinguished.

The communication control device 1 has a storage unit 10, a server activation control unit 11, an assignment control unit 12, a communication control unit 13, a transfer destination server management unit 14, a server suspension control unit 15, a call connection number management unit 16, a call information access control unit 17, a call number management unit 18, and a prediction activation control unit 19.

The storage unit 10 stores pieces of data of a server status management table 101, a call connection information list 102, server management information 103, and call information 104.

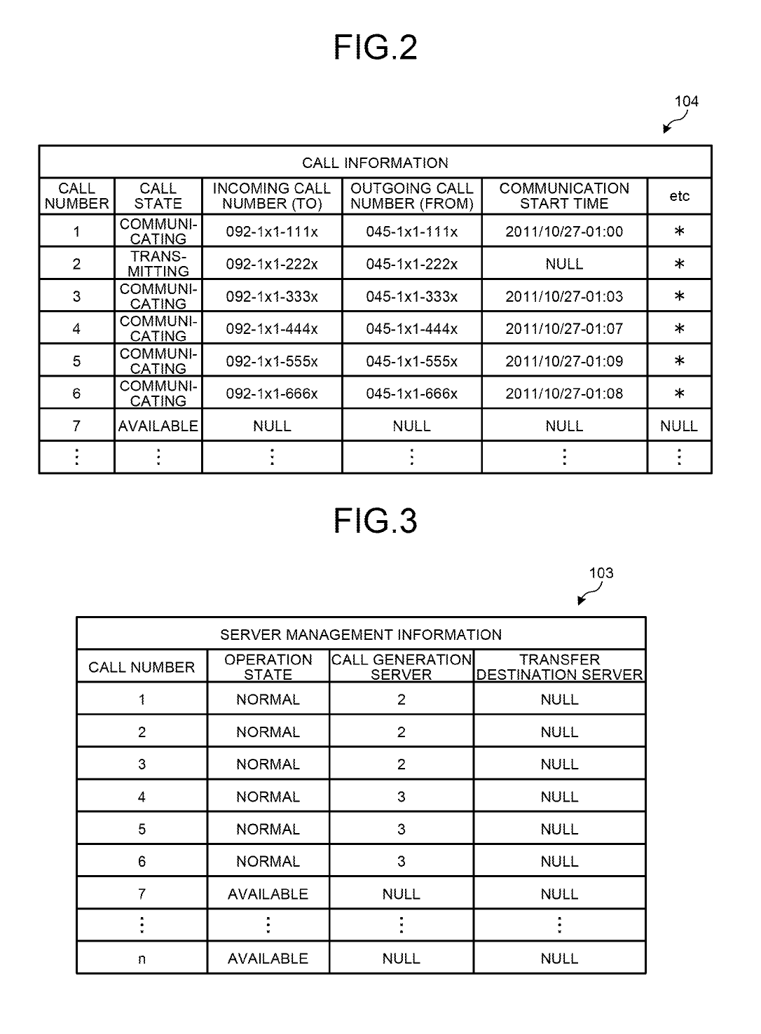

FIG. 2 is a diagram of an example of call information. As illustrated in FIG. 2, the call information 104 is a table with which a call number, a call status, an incoming call number, an outgoing call number, a communication start time, and other information are registered so that these pieces of information correspond to each other. The call status is information indicating a status of a call such as whether the call to which the call number is allocated is in communication or not. “Communicating” in the call status is a state where the network is already formed between a terminal on the transmission side and a terminal on the reception side. “Transmitting” in the call status is a state where the terminal on the reception side is receiving the calling from the terminal on the transmission side. The incoming call number is information indicating a phone number of a device on the reception side. The outgoing call number is information indicating a phone number of a device on the transmission side. The communication start time is information representing a time at which the communication has started between the device on the transmission side and the device on the reception side. The other information is information represented by “etc.” in FIG. 2, and is various kinds of information associated with the call.

FIG. 3 is a diagram of an example of server management information. For example, as illustrated in FIG. 3, the server management information 103 is a table with which the call number, an operation state, a call generation server, and a transfer destination server are registered so that these pieces of information correspond to each other. The operation state is information representing whether or not the calling process of the call to which the call number has been allocated is being managed by the call control server that has generated the call or whether or not the calling process has been transferred from the call generation server to other call control server and is being managed by the call control server at the transfer destination. Further, the call generation server is information of the call control server that has generated the call to which the call number has been allocated. The call control server that has generated the call may be hereinafter referred to as a “call generation server”. The transfer destination server is information of the call control server to which the call process has been transferred, in the case where the calling process has been transferred from the call generation server (to be described below) to other call control server. The call control server to which the calling process has been transferred may be hereinafter referred to as a “transfer destination server”. In the server management information 103, the operation state corresponding to the call number which has not been allocated to the call is described as “available” and the call generation server and the transfer destination server are described as “NULL”.

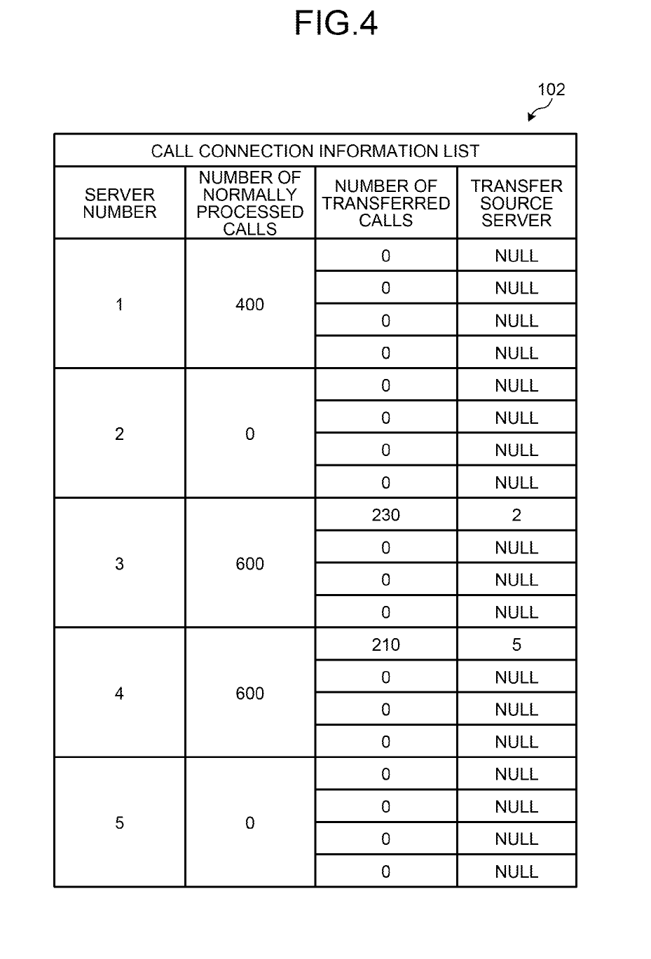

FIG. 4 is a diagram of an example of a call connection information list. For example, the call connection information list 102 is, as illustrated in FIG. 4, a table with which the server number, the number of normally processed calls, the number of transferred calls, and a transfer source server are registered so that these pieces of information correspond to each other. The server number is identification information of the call control servers 20. The number of normally processed calls is the number of calls that are generated and being managed by the call control server 20 having the corresponding server number. The number of transferred calls is the number of calls for each transfer source server of the call from which the calling process has been transferred to the call control server 20 having the corresponding server number. The transfer source server is the call control server 20 that has managed the calling process transferred to the call control server 20 having the corresponding server number before the transfer. The call connection information list 102 is generated by the call connection number management unit 16 to be described below.

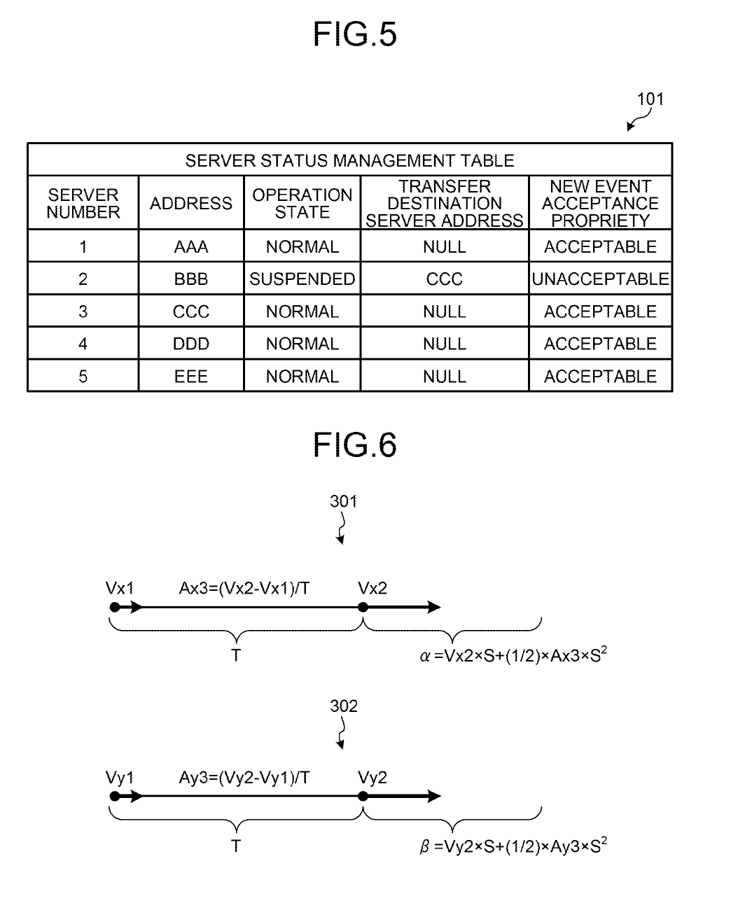

FIG. 5 is a diagram of an example of a server status management table. For example, the server status management table 101 is, as illustrated in FIG. 5, a table with which the server number, an address, the operation state, a transfer destination server address, and new event acceptance propriety are registered so that these pieces of information correspond to each other. The server number is the identification information of the call control servers 20. The address is an address of the call control server 20 having the corresponding server number. The operation state is information representing whether the call control server 20 having the corresponding server number is in operation or suspended. The transfer destination server address is an address of the call control server 20 to which the calling process of the call control server 20 having the corresponding server number has been transferred. The new event acceptance propriety is information representing whether or not the call control server 20 having the corresponding server number can accept a new event.

The communication control unit 13 receives data from the transmission side system 30 and the reception side system 40, and outputs the received data to each unit that processes the data. Further, the communication control unit 13 receives the data output from each unit and transmits the data to the call control server 20, the transmission side system 30 and the reception side system 40. Each unit of the communication control device 1 actually exchanges the data with the call control server 20, the transmission side system 30, and the reception side system 40 through the communication control unit 13 in this manner. In the description below, however, the data may be described as being exchanged between each unit and the call control server 20 for the convenience.

The call number management unit 18 receives a call number acquisition request from the call control server 20 that has received a request of call setting from the transmission side system 30. The call number management unit 18 checks the call status of the call information 104, and specifies the call number that is not used. The call number management unit 18 allocates the call number that is not used to the call number acquisition request from the call control server 20. The call number management unit 18 then transmits the allocated call number to the call control server 20 that has transmitted the call number acquisition request.

Moreover, the call number management unit 18 registers “normal” in the column of the operation state of the server management information 103 corresponding to the allocated call number. The call number management unit 18 also registers the identification information of the call control server 20 that has transmitted the call number with the column of the call generation server of the server management information 103 corresponding to the allocated call number.

The call number management unit 18 further registers “normal” in the column of the operation state of the server management information 103 corresponding to the allocated call number. In addition, the call number management unit 18 registers the identification information of the call control server 20 that has transmitted the call number with the column of the call generation server of the server management information 103 corresponding to the allocated call number.

The call information access control unit 17 has an exclusive control function of, for example, making the information of the call being managed by a certain call control server 20 inaccessible from the other call control server 20. The call information access control unit 17 then provides a function for allowing the call control server 20 to access the call information 104 according to the call number for reference, updating or the like.

For example, in the case of establishing the communication, the call information access control unit 17 receives the information such as the call number allocated by the call number management unit 18 and the outgoing call number or the incoming call number corresponding to that call number from the call control server 20. Then, the call information access control unit 17 registers the received information such as the outgoing call number or the incoming call number with the call information 104. Further, the call information access control unit 17 changes the call status of the call information 104 corresponding to the received call number to a calling status. Subsequently, upon receiving a call information readout request from the call control server 20, the call information access control unit 17 reads out the call information 104 and transmits the information to the call control server 20. Further, after the status of the call has transited, the call information access control unit 17 receives a call information writing request from the call control server 20. The call information access control unit 17 then changes the call status of the call information 104 to represent a transition status of the call. Then, when a communication state is made, the call information access control unit 17 changes the call status of the call information 104 to “communicating”.

In the case of ending the communication, similarly, upon receiving the call information readout request from the call control server 20, the call information access control unit 17 reads out the call information 104 and transmits the information to the call control server 20. Further, after the status of the call has transited, the call information access control unit 17 receives the call information writing request from the call control server 20. Then, the call information access control unit 17 changes the call status of the call information 104 to represent the transition status of the call. Then, when the communication has been successfully disconnected, the call information access control unit 17 changes the call status in the call information 104 corresponding to the call number of the call whose communication has been successfully disconnected to “available”. In addition, the call information access control unit 17 deletes the incoming call number, the outgoing call number, the communication start time, and the other information corresponding to the call number from the call information 104.

Upon receiving a call connection information acquisition request from the server suspension control unit 15 to be described below, the call connection number management unit 16 extracts the calling process whose operation state in the server management information 103 is “normal” and accumulates the processes for each call generation server. The call connection number management unit 16 then registers the accumulation result with the number of normally processed call of each call control server 20 in the call connection information list 102. Further, the call connection number management unit 16 extracts the calling process whose operation state in the server management information 103 is “transfer” and accumulates the processes for each transfer destination server and for each call generation server. The call connection number management unit 16 then specifies the call control server 20 in the call connection information list 102 corresponding to each transfer destination server that has been subjected to the accumulation. The call connection number management unit 16 registers the identification information of the call control server 20 of which transfer destination server is the specified call control server 20 in the server management information 103 with the column of the server number corresponding to the specified call control server 20 in the call connection information list 102. Moreover, the call connection number management unit 16 registers the accumulation result with the column of the number of transferred calls corresponding to the registered transfer source server number.

The server suspension control unit 15 regularly transmits the call connection information acquisition request to the call connection number management unit 16. Here, when a period of transmitting the call connection information acquisition request is shorter, a frequency of suspending the server can be increased, so that the power consumption can be reduced further, but a load applied to the communication control device 1 is increased. In view of this, the period of transmitting the call connection information acquisition request is preferably determined in accordance with operation circumstances.

The server suspension control unit 15 refers to the call connection information list 102 updated by the call connection number management unit 16, and determines whether or not there is a server that can be suspended. Here, detailed description is made of the determination on the server that can be suspended by the server suspension control unit 15.

The server suspension control unit 15 stores in advance a server suspension monitor threshold for determining whether the server can be suspended or not. For example, the server suspension monitor threshold can be set to 20% of a maximum load. Then, the server suspension control unit 15 acquires the number of normally processed calls and the number of transferred calls managed by each call control server 20 from the call connection information list 102. Then, the server suspension control unit 15 calculates the number of call connections by summing up the number of normally processed calls and the number of transferred calls for each call control server 20. Subsequently, the server suspension control unit 15 sorts the call control servers 20 in the ascending order of the numbers of call connections. The server suspension control unit 15 then selects check target servers one by one from the top to the bottom in the ascending order, and repeats the process as below. The server suspension control unit 15 determines whether or not there is a server in which, between the call control server 20 next the check target server in the order and the lowest call control server 20, the server suspension monitor threshold is not exceeded even by adding the number of call connections of the check target server to the call connection number managed by that server. When there is a server in which the server suspension monitor threshold is not exceeded even by adding the number of call connections of the check target server, the server suspension control unit 15 determines that the check target serve is a suspension target server. This suspension target server corresponds to one example of a “first call control server”. Then, the server suspension control unit 15 decides that the transfer destination server is the call control server 20 whose order is the lowest among the servers in which the server suspension monitor threshold is not exceeded even by adding the number of call connections of the suspension target server. The server suspension control unit 15 then obtains as a calculation result the number of calling processes that have come to be managed by each call control server 20 due to the transfer of the calling processes. The server suspension control unit 15 holds this calculation result even when the check target server has moves to the next call control server 20, and updates the result every time the transfer of the calling process occurs.

When the checking whether or not the call control server 20 can be suspended has been completed for the call control servers 20, the server suspension control unit 15 notifies the assignment control unit 12 of the stop of the assignment of the suspension target servers.

Moreover, the server suspension control unit 15 notifies the transfer destination server management unit 14 of the change of the operation state of the suspension target server to “suspended” and the registration of the transfer destination server in the server management information 103.

Upon the reception of the notification that the update of the server management information 103 has been completed from the transfer destination server management unit 14, the server suspension control unit 15 notifies the assignment control unit 12 of the transfer destination server of the call having managed by the suspension target server and instructs the assignment control unit 12 to update the server status management table 101.

Next, the server suspension control unit 15 transmits the suspension order to the call control server 20 serving as the suspension target server.

The server activation control unit 11 regularly transmits the call connection information acquisition request to the call connection number management unit 16. Here, when the period of transmitting the call connection information acquisition request is shorter, a frequency of activating the server can be increased, so that the increase in a load applied to the server can be suppressed, but a load applied to the communication control device 1 is increased. In view of this, the period of transmitting the call connection information acquisition request is preferably determined in accordance with operation circumstances.

The server activation control unit 11 refers to the server status management table 101, and determines whether or not there is a suspended server. When there is a suspended server, the server activation control unit 11 refers to the call connection information list 102 updated by the call connection number management unit 16, and determines whether or not there is the call control server 20 that has a load exceeding a server activation monitor threshold that is stored in advance. The call control server 20 having a load exceeding the server activation monitor threshold may hereinafter be referred to as a “high-load server”. Here, the server activation monitor threshold has a value lower than the server suspension monitor threshold. For example, when the server suspension monitor threshold is 20% of the maximum load, the server activation monitor threshold can be set to 50% of the maximum load.

When there is the high-load server, the server activation control unit 11 decides to return the calling process transferred to the high-load server back to the transfer source server. The server activation control unit 11 notifies the transfer destination server management unit 14 of a request of updating the server management information.

Upon the reception of the notification that the update of the server management information 103 has been completed from the transfer destination server management unit 14, the server activation control unit 11 transmits the activation order to the call control server 20 serving as the transfer source server to which the calling process is returned.

Moreover, the server activation control unit 11 notifies the transfer destination server management unit (server status management unit) of information of the high-load server and instructs the assignment control unit 12 to update the server status management table 101.

Moreover, the server activation control unit 11 instructs the transfer destination server management unit 14 to change the operation state of the transfer source server to which the calling process is returned to “normal” and to return the transfer destination server to “NULL” in the server management information 103.

The prediction activation control unit 19 regularly (periodically) transmits the call connection information acquisition request to the call connection number management unit 16. A value obtained in a current period is hereinafter referred to as a “current value” simply, and a value obtained in a previous period is hereinafter referred to as a “previous value” simply.

Next, the prediction activation control unit 19 refers to the call connection information list 102 updated by the call connection number management unit 16, and acquires the number of outgoing calls, which is the number of calls that are being made and are being processed by the call control server 20 in operation, and the number of communicating calls, which is the number of calls in the middle of communication. The prediction activation control unit 19 then subtracts the previous number of outgoing calls from the current number of outgoing calls and divides the subtraction result by the period, thereby obtaining an “outgoing call speed”, which is an increase rate of the number of outgoing calls for each call control server 20 in operation. Here, the previous number of outgoing calls is assumed to be X1, the current number of outgoing calls is assumed to be X2, and further the period is assumed to be T. Moreover, a current outgoing call speed is assumed to be Vx2. In this case, the prediction activation control unit 19 obtains the outgoing call speed from a formula: Vx2=(X2−X1)/T.

Similarly, the prediction activation control unit 19 subtracts the previous number of communicating calls from the current number of communicating calls and divides the subtraction result by the period, thereby obtaining a “communicating call speed” which is an increase rate of the number of communicating calls for each call control server 20 in operation. Here, the previous number of communicating calls is assumed to be Y1, the current number of communicating calls is assumed to be Y2, and further the period is assumed to be T. Moreover, a current communicating call speed is assumed to be Vy2. In this case, the prediction activation control unit 19 obtains the communicating call speed from a formula: Vy2=(Y2−Y1)/T.

Next, the prediction activation control unit 19 subtracts a previous outgoing call speed that has been already obtained from the obtained current outgoing call speed, and divides the subtraction result by the period, thereby obtaining “outgoing call acceleration” which is a change rate of the increase rate of the number of outgoing calls for each call control server 20 in operation. Here, the previous outgoing call speed is assumed to be Vx1. The same symbol may be used in the description below. In this case, the prediction activation control unit 19 obtains the outgoing call acceleration from a formula: (Vx2−Vx1)/T.

Similarly, the prediction activation control unit 19 subtracts a previous communicating call speed that has been already obtained from the obtained current communicating call speed, and divides the subtraction result by the period, thereby obtaining “communicating call acceleration” which is a change rate of the increase rate of the number of communicating calls for each call control server 20 in operation. Here, the previous communicating call speed is assumed to be Vy1. The same symbol may be used in the description below. In this case, the prediction activation control unit 19 obtains the communicating call acceleration from a formula: (Vy2−Vy1)/T.

Next, the prediction activation control unit 19 adds the outgoing call acceleration before the previous one, the previous outgoing call acceleration, and the current outgoing call acceleration, and divides the obtained value by three to obtain an average value of the outgoing call acceleration. Here, when the outgoing call acceleration before the previous one is assumed to be Ax1, the previous outgoing call acceleration is assumed to be Ax2, and the current outgoing call acceleration is assumed to be Ax3, the prediction activation control unit 19 obtains the average value of the outgoing call acceleration from a formula: (Ax1+Ax2+Ax3)/3. The average value of the outgoing call acceleration can be said to be an average value of the change rates of the increase rates of the numbers of outgoing calls for each call control server 20 in operation, and represents a change trend of the increase rate of the number of outgoing calls.

Similarly, the prediction activation control unit 19 adds the communicating call acceleration before the previous one, the previous communicating call acceleration, and the current communicating call acceleration, and divides the obtained value by three to obtain an average value of the communicating call acceleration. Here, when the communicating call acceleration before the previous one is assumed to be Ay1, the previous communicating call acceleration is assumed to be Ay2, and the current communicating call acceleration is assumed to be Ay3, the prediction activation control unit 19 obtains the average value of the communicating call acceleration from a formula: (Ay1+Ay2+Ay3)/3. The average value of the communicating call acceleration can be said to be an average value of the change rates of the increase rates of the numbers of communicating calls for each call control server 20 in operation, and represents a change trend of the increase rate of the number of communicating calls.

Next, the prediction activation control unit 19 subtracts the current number of outgoing calls and the current number of communicating calls from the maximum connection number of each call control server 20 in operation to obtain a “remaining resource”, which is the number of newly available call connections for each call control server 20 in operation. Here, when the maximum connection number is assumed to be M and the remaining resource is assumed to be N, the prediction activation control unit 19 obtains the remaining resource from a formula: N=M−(X2+Y2).

Next, the prediction activation control unit 19 adds a value obtained by multiplying the outgoing call speed by a server operation time and a value obtained by dividing by two the result of multiplying a square of the server operation time by the average value of the outgoing call acceleration for each call control server 20 in operation, thereby calculating the number of outgoing calls after the elapse of the server operation time. Here, when the server operation time is assumed to be S and the average value of the outgoing call acceleration is assumed to be Ax, the prediction activation control unit 19 obtains an increase of the number of outgoing calls after the elapse of the server operation time from a formula: Vx2×S+(½)×Ax×S².

Similarly, the prediction activation control unit 19 adds a value obtained by multiplying the communicating call speed by the server operation time and a value obtained by dividing by two the result of multiplying a square of the server operation time by the average value of the communicating call acceleration for each call control server 20 in operation, thereby calculating the number of communicating calls after the elapse of the server operation time. Here, when the server operation time is assumed to be S and the average value of the communicating call acceleration is assumed to be Ay, the prediction activation control unit 19 obtains an increase of the number of communicating calls after the elapse of the server operation time from a formula: Vy2×S+(½)×Ay×S².

Here, description is made again of the calculation of the outgoing call number acceleration and the increase of the number of outgoing calls after the elapse of the server operation time assuming that the increase of the number of outgoing calls after the elapse of the server operation time is a and the increase of the number of communicating calls after the elapse of the server operation time is β.

FIG. 6 is a diagram for describing the calculation of the call acceleration and the increase of the number of calls after the elapse of the server operation time. A graph 301 represents the relation between the outgoing call acceleration and the increase in the number of outgoing calls. Further, a graph 302 represents the relation between the communicating call acceleration and the increase in the number of communicating calls.

The relation between the outgoing call speed and the outgoing call acceleration can be considered similar to the general relation between a speed and acceleration. In other words, when an initial speed of the outgoing call speed is assumed to be Vx1 and a speed after T seconds is assumed to be Vx2, it can be said that a speed is increased by Vx2−Vx1 in T seconds. That is, the outgoing call acceleration Ax3 is represented by (Vx2−Vx1)/T as indicated in the graph 301.

Then, the increase a of the number of outgoing calls after S seconds from the state where the speed is Vx2 becomes Vx2×S+(½)×Ax3×S² by using a general relation formula between the speed and the acceleration as indicated in the graph 301. Here, for the convenience of the description, the increase of the number of outgoing calls is obtained by using one outgoing call acceleration without obtaining the average of the outgoing call acceleration.

The relation between the communicating call speed and the communicating call acceleration can be considered in a similar manner to the general relation between the speed and the acceleration. In other words, when the initial speed of the outgoing call speed is assumed to be Vy1 and the speed after T seconds is assumed to be Vy2, it can be said that the speed is increased by Vy2−Vy1 in T seconds. That is, the outgoing call acceleration Ay3 is represented by (Vy2−Vy1)/T as indicated in the graph 302.

The increase β of the number of outgoing calls after S seconds from the state where the speed is Vy2 becomes Vy2×S+(½)×Ay3×S² by using the general relation formula between the speed and the acceleration.

For example, when Vx1=13, Vx2=10, T=5, and S=30, then Ax3 is (13−10)/5=0.6. In this case, the increase of the number of outgoing calls is 13×30+(½)×0.6×30²=660. Therefore, the increase of the number of outgoing calls after 30 seconds when the initial speed of the number of outgoing calls is 10 and the speed has reached 13 in 5 seconds becomes 660.

The prediction activation control unit 19 then compares the total of the increase of the number of outgoing calls and the increase of the number of the communicating calls after the elapse of the server operation time and the remaining resource for each call control server 20 in operation. The prediction activation control unit 19 decides the restart of the suspended server when the total of the increase of the number of outgoing calls and the increase of the number of the communicating calls after the elapse of the server operation time is larger than the remaining resource. In other words, the prediction activation control unit 19 decides the restart of the suspended server when α+β>N is satisfied.

When the restart of the suspended server has been decided, the prediction activation control unit 19 refers to the server status management table 101, and determines whether or not there is the suspended server. When there is the suspended server, the prediction activation control unit 19 decides to return to the transfer source server the calling process that has been transferred to the call control server 20 in which the total of the number of outgoing calls and the number of the communicating calls after the elapse of the server operation time is larger than the remaining resource. The prediction activation control unit 19 notifies the transfer destination server management unit 14 of the request of updating the server management information 103.

Upon the reception of the notification that the update of the server management information 103 has been completed from the transfer destination server management unit 14, the server prediction activation control unit 19 transmits the activation order to the call control server 20 serving as the transfer source server to which the calling process is returned.

Moreover, the server prediction activation control unit 19 notifies the transfer destination server management unit 14 of the information of the call control server 20 to which the managed call is transferred, and instructs the assignment control unit 12 to update the server status management table 101.

Moreover, the prediction activation control unit 19 instructs the transfer destination server management unit 14 to change the operation state of the transfer source server to which the calling process is returned to “normal” and to return the transfer destination server to “NULL” in the server management information 103.

Here, the prediction activation control unit 19 periodically performs a server activation process using the prediction of the number of calls described above. In other words, the prediction activation control unit 19 periodically transmits the call connection information acquisition request to the call connection number management unit 16.

Then, the transmission of the call connection information acquisition request by the prediction activation control unit 19 may be at the same timing as or different timing from the server activation control unit 11. For example, a part of the call connection information acquisition request from the prediction activation control unit 19 may be treated as the call connection information acquisition request from the server activation control unit 11. Moreover, the server activation control unit 11 and the prediction activation control unit 19 may be unified.

The transfer destination server management unit 14 receives from the server suspension control unit 15 a request for the change of the operation state of the suspension target server to “suspended” in the server management information 103 and for the registration of the transfer destination server with the server management information 103. The transfer destination server management unit 14 then changes the operation state of the suspension target server to “suspended” in the server management information 103, and then registers the identification information of the transfer destination server to which the call has been transferred from the suspension target server with the server management information 103. Subsequently, the transfer destination server management unit 14 outputs to the server suspension control unit 15 the notification that the update of the server management information 103 has been completed.

Moreover, the transfer destination server management unit 14 receives from the server suspension control unit 15 a request for the change of the transfer source server to which the calling process is returned to “normal” and the return of the transfer destination server to “NULL” in the server management information 103. Then, the transfer destination server management unit 14 changes the operation state of the transfer source server to which the calling process is returned to “normal” and then returns the transfer destination server to “NULL” in the server management information 103. Subsequently, the transfer destination server management unit 14 outputs to the server activation control unit 11 the notification that the update of the server management information 103 has been completed.

The assignment control unit 12 receives the request of the call setting from the transmission side system 30. The assignment control unit 12 then selects the server that sets the call from among the call control servers 20. Subsequently, the assignment control unit 12 notifies the selected call control server 20 of the information of the transmission side system 30 and the reception side system 40, and performs the call setting on the selected call control server 20.

The assignment control unit 12 receives an instruction for stopping the assignment of new events from the server suspension control unit 15. The assignment control unit 12 then causes an event such as the call setting requested after that not to be assigned to the suspension target server.

Subsequently, the assignment control unit 12 receives from the server suspension control unit 15 the notification of the transfer destination server of the calling process have been managed by the suspension target server and an instruction of the update of the server status management table 101. The assignment control unit 12 then changes the operation state of the suspension target server to “suspended” in the server status management table 101. Moreover, the assignment control unit 12 writes the address of the transfer destination server of the calling process of the suspension target server in the transfer destination server address, and sets the new event acceptance propriety to “unacceptable”.

Moreover, the assignment control unit 12 receives from the server activation control unit 11 an instruction of changing the operation state of the transfer source server to which the calling process is returned to “normal” and returning the transfer destination server to “NULL” in the server management information 103. The assignment control unit 12 then changes the operation state of the transfer source server to which the calling process is returned to “in operation”, returns the transfer destination server address to “NULL”, and sets the new event acceptance propriety to “acceptable”.

Next, the call control server is described. Here, an example of the call control server 21 is described; however, any call control server 20 has a similar function. The call control server 21 has a communication control unit 201, a call process unit 202, and a power source control unit 203.

The communication control unit 201 controls communication among the communication control device 1, the transmission side system 30, and the reception side system 40.

The call process unit 202 preforms a process of the call set by the communication control device 1. For example, the call process unit 202 generates and transmits the call information to be sent to the communication control device 1, and creates and transmits signals to be transmitted to the transmission side system 30 and the reception side system 40. In the case where the call process unit 202 generates the signals to be transmitted to the transmission side system 30 and the reception side system 40, a Via header and a Record-Router header are edited so as to travel via the assignment control unit 12 of the communication control device 1.

Upon receiving the suspension order from the server suspension control unit 15 of the communication control device 1, the power source control unit 203 starts a suspension process of the call control server 21 and subsequently turns off a power source. Moreover, upon receiving the activation order from the server activation control unit 11 of the communication control device 1, the power source control unit 203 turns on the power source of the call control server 21 to start the activation process. This power source control unit 203 corresponds to one example of a “suspension control unit”.

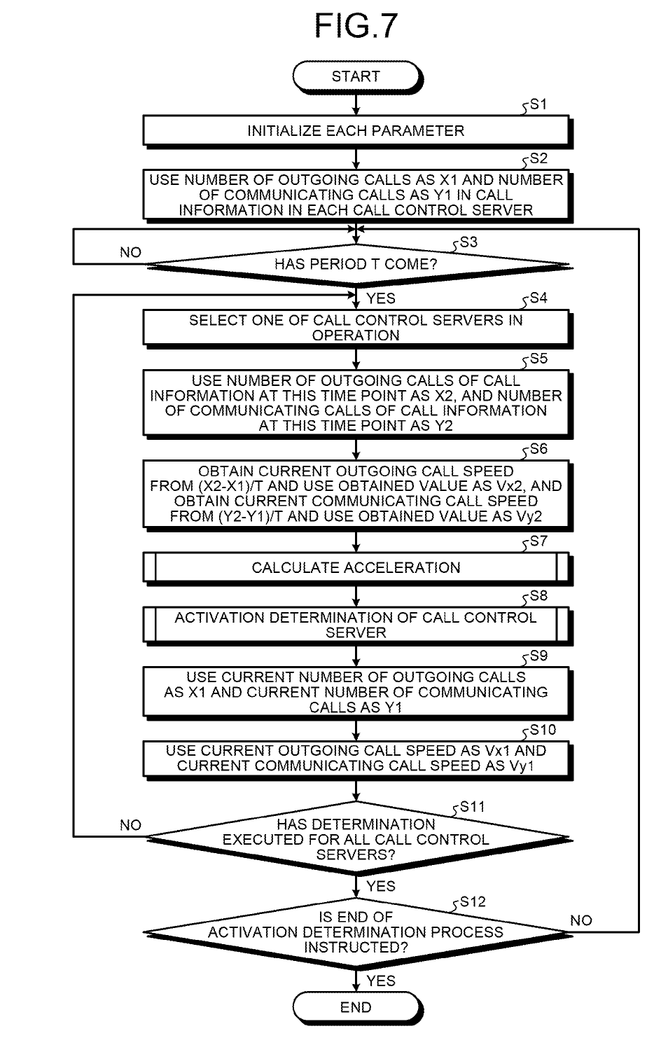

Next, description is made of a process of activation determination of the call control server 20 using the prediction of the increase in the number of calls by the communication control device 1 according to this embodiment with reference to FIG. 7. FIG. 7 is a flowchart of the process of the activation determination of the call control server using the prediction of the increase in the number of calls by the communication control device according to the first embodiment.

The prediction activation control unit 19 initializes each parameter (Step S1). The parameters include the previous number of outgoing calls (X1), the previous number of communicating calls (Y1), the current number of outgoing calls (X2), the current number of communicating calls (Y2), the previous outgoing call speed (Vx1), and the previous communicating call speed (Vy1). The parameters also include the current outgoing call speed (Vx2), the current communicating call speed (Vy2), the outgoing call acceleration before the previous one (Ax1), the communicating call acceleration before the previous one (Ay1). Moreover, the parameters include the previous outgoing call acceleration (Ax2), the previous communicating call acceleration (Ay2), the current outgoing call acceleration (Ax3), and the current communicating call acceleration (Ay3).

Next, the prediction activation control unit 19 uses the number of going calls registered with the call information 104 as X1 and the number of communicating calls registered with the call information 104 as Y1 in each call control server 20 (Step S2).

Subsequently, the prediction activation control unit 19 determines whether the period T has come or not (Step S3). When the period T has not come yet (No in Step S3), the prediction activation control unit 19 stands-by until the period T comes.

On the other hand, when the period T has come (Yes in Step S3), the prediction activation control unit 19 selects one of the call control servers 20 in operation (Step S4).

Next, the prediction activation control unit 19 uses the number of outgoing calls registered with the call information 104 at this time point as X2 and the number of communicating calls registered with the call information 104 at this time point as Y2 (Step S5).

Then, the prediction activation control unit 19 obtains the current outgoing call speed by using the previous number of outgoing calls (X1), the current number of outgoing calls (X2), and the period (T) in a formula of (X2−X1)/T, and uses the obtained outgoing call speed as Vx2. The prediction activation control unit 19 also obtains the current communicating call speed by using the previous number of communicating calls (Y1), the current number of communicating calls (Y2), and the period (T) in a formula of (Y2−Y1)/T, and uses the obtained outgoing call speed as Vy2 (Step S6).

Next, the prediction activation control unit 19 calculates the outgoing call acceleration and the communicating call acceleration (Ax, Ay) (Step S7). Detailed description will be made below of a process of calculating the outgoing call acceleration and the communicating call acceleration.

Next, the prediction activation control unit 19 performs the activation determination of the call control server 20 by using the obtained outgoing call speed, communicating call speed, outgoing call acceleration, and communicating call acceleration (Step S8). Detailed description will be made below of a process of the activation determination of the call control server 20.

Then, the prediction activation control unit 19 uses the current number of outgoing calls as X1 and the current number of communicating calls as Y1 (Step S9).

Moreover, the prediction activation control unit 19 uses the current outgoing call speed as Vx1 and the current communicating call speed as Vy1 (Step S10).

Subsequently, the prediction activation control unit 19 determines whether or not the activation determination of the call control server 20 based on the prediction of the number of calls has been performed on all the call control servers 20 in operation (Step S11). When there is the call control server 20 in operation on which the activation determination has not yet been performed (No in Step S11), the prediction activation control unit 19 returns to Step S4.

On the other hand, when the activation determination on all the call control servers 20 in operation have been completed (Yes in Step S11), the prediction activation control unit 19 determines whether an instruction of ending the activation determination process of the call control server 20 has been received or not (Step S12). The instruction of ending the activation determination process of the call control server 20 is, for example, an instruction of shutting down for the communication control device 1. In the case where the instruction of ending the activation determination process of the call control server 20 has been received (Yes in Step S12), the prediction activation control unit 19 ends the process of the activation determination of the call control server 20.

On the other hand, in the case where the instruction of ending the activation determination process of the call control server 20 has not received (No in Step S12), the prediction activation control unit 19 returns to Step S3.

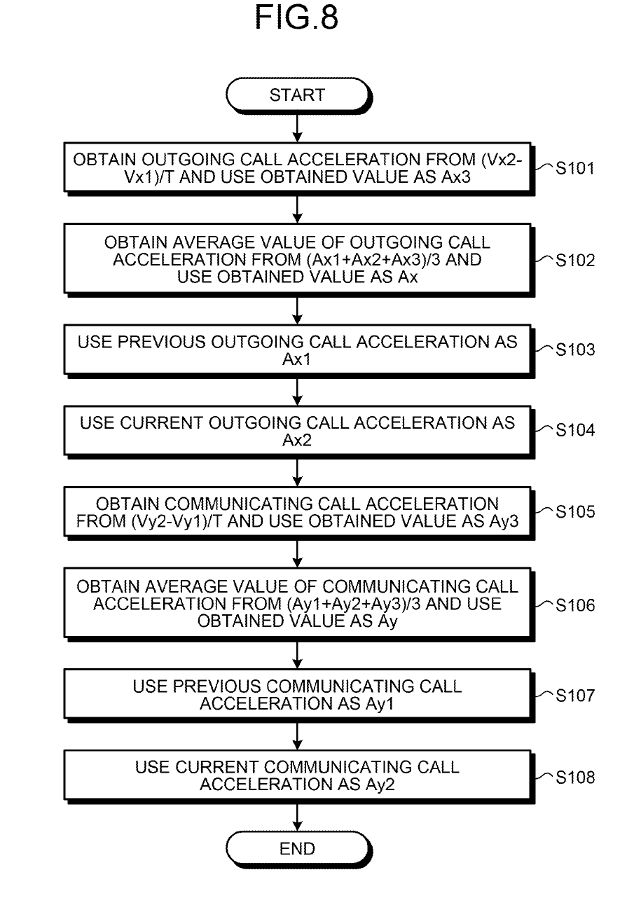

Next, description is made of the calculation of the outgoing call acceleration and the communicating call acceleration with reference to FIG. 8. FIG. 8 is a flowchart of the process of calculating the outgoing call acceleration and the communicating call acceleration. The process described in the flowchart of FIG. 8 is an example of the process executed in Step S7 of FIG. 7.

The prediction activation control unit 19 obtains the current outgoing call acceleration by using the current outgoing call speed (Vx2), the previous outgoing call speed (Vx1), and the period (T) in the formula of (Vx2−Vx1)/T, and uses the obtained outgoing call acceleration as Ax3 (Step S101).

The prediction activation control unit 19 then obtains the average value of the outgoing call acceleration by using the outgoing call acceleration before the previous one (Ax1), the previous outgoing call acceleration (Ax2), and the current outgoing call acceleration (Ax3) in the formula of (Ax1+Ax2+Ax3)/3. Then, the prediction activation control unit 19 uses the obtained average value of the outgoing call acceleration as Ax (Step S102). In the case where the previous outgoing call acceleration and the outgoing call acceleration before the previous one are absent, however, the current outgoing call acceleration may be used as Ax or the calculation of Ax may be started from a period where the previous outgoing call acceleration and the outgoing call acceleration before the previous one are present.

Next, the prediction activation control unit 19 uses the previous outgoing call acceleration as Ax1 (Step S103).

Moreover, the prediction activation control unit 19 uses the current outgoing call acceleration as Ax2 (Step S104).

The prediction activation control unit 19 also obtains the communicating call acceleration by using the current communicating call speed (Vy2), the previous communicating call speed (Vy1), and the period T in the formula of (Vy2−Vy1)/T, and uses the obtained communicating call acceleration as Ay3 (Step S105).

Next, the prediction activation control unit 19 obtains the average value of the communicating call acceleration by using the communicating call acceleration before the previous one (Ay1), the previous communicating call acceleration (Ay2), and the current communicating call acceleration (Ay3) in the formula of (Ay1+Ay2+Ay3)/3. Then, the prediction activation control unit 19 uses the obtained average value of the communicating call acceleration as Ay (Step S106). In the case where the previous communicating call acceleration and the communicating call acceleration before the previous one are absent, however, the current communicating call acceleration may be used as Ay or the calculation of Ay may be started from the period where the previous communicating call acceleration and the communicating call acceleration before the previous one are present.

Next, the prediction activation control unit 19 uses the previous communicating call acceleration as Ay1 (Step S107).

Moreover, the prediction activation control unit 19 uses the current communicating call acceleration as Ay2 (Step S108).

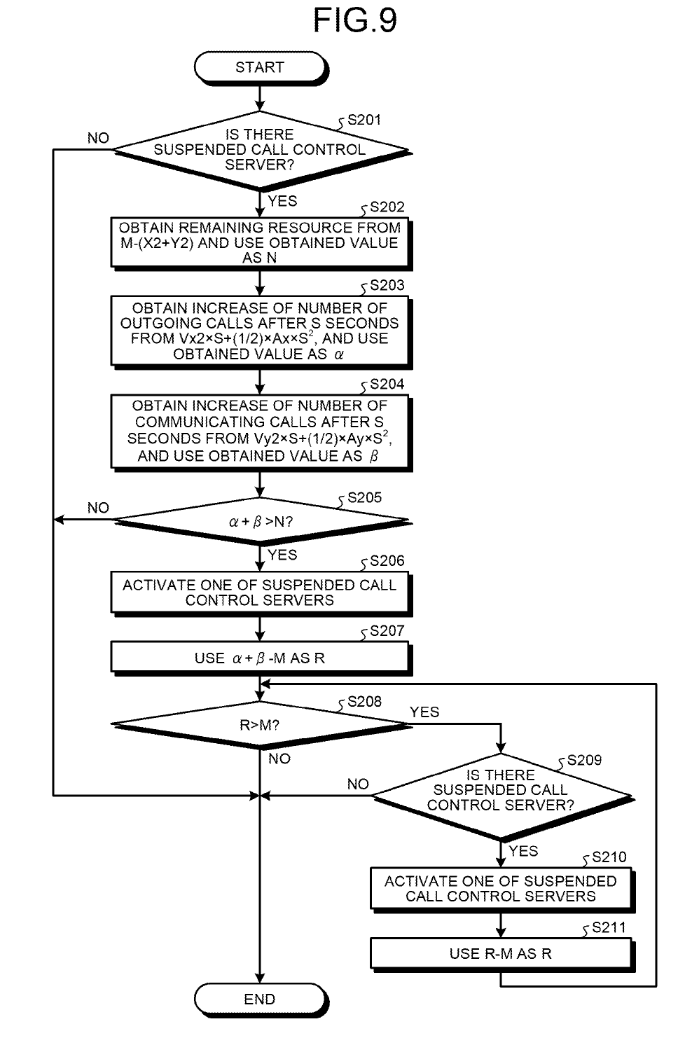

Next, description is made of the activation determination of the call control server 20 by the communication control device 1 according to this embodiment with reference to FIG. 9. FIG. 9 is a flowchart of the process of the activation determination of the call control server by the communication control device according to the first embodiment. The process described in the flowchart of FIG. 9 is one example of the process performed in Step S8 in FIG. 7.

The prediction activation control unit 19 determines whether or not there is the suspended call control server 20 (Step S201). In this embodiment, the prediction activation control unit 19 determines whether or not there is the suspended call control server 20 in the transfer source servers which are transferring the calling process to the call control servers 20 in which the sum of the increase of the number of outgoing calls and the increase of the number of the communicating calls after S seconds exceeds the remaining resource. When there is no suspended call control server 20 (No in Step S201), the prediction activation control unit 19 ends the process of the activation determination of the call control server 20.

On the other hand, when there is the suspended call control server 20 (Yes in Step S201), the prediction activation control unit 19 obtains the remaining resource by using the maximum connection number (M) of the call control server 20, the current number of outgoing calls (X2), and the current number of communicating calls (Y2) in a formula of M−(X2+Y2) the use of. Then, the prediction activation control unit 19 uses the obtained remaining resource as N (Step S202).

Next, the prediction activation control unit 19 obtains the increase of the number of outgoing calls after S seconds by using the current outgoing call speed (Vx2), the server operation time (S), and the average value of the outgoing call acceleration (Ax) in the formula of Vx2×S+(½)×Ax×S². Then, the prediction activation control unit 19 uses the obtained increase of the number of outgoing calls as a (Step S203).

Moreover, the prediction activation control unit 19 obtains the increase of the number of communicating calls after S seconds by using the current communicating call speed (Vy2), the server operation time (S), and the average value of the communicating call acceleration (Ay) in the formula of Vy2×S+(½)×Ay×S². Then, the prediction activation control unit 19 uses the obtained increase of the number of communicating calls as 13 (Step S204).

Next, the prediction activation control unit 19 determines whether or not α+β, which is the sum of the increase of the number of outgoing calls and the increase of the number of communicating calls after S seconds, is larger than N, which is the remaining resource (Step S205). When α+β is less than or equal to N (No in Step S205), the prediction activation control unit 19 ends the process of the activation determination of the call control server 20.

On the other hand, when α+β is larger than N (Yes in Step S205), the prediction activation control unit 19 activates one of the suspended call control servers 20 (Step S206). Here, in this embodiment, the prediction activation control unit 19 selects one call control server 20 to be activated from among the transfer source servers that are transferring the calling process to the call control servers 20 in which the sum of the increase of the number of outgoing calls and the increase of the number of communicating calls after S seconds exceeds the remaining resource.

Next, the prediction activation control unit 19 uses as R, a value obtained by subtracting the maximum connection number from the sum of the increase of the number of outgoing calls and the increase of the number of communicating calls after S seconds, i.e., α+β−M (Step S207).

Next, the prediction activation control unit 19 determines whether or not R is larger than the maximum connection number (M) (Step S208). In other words, the prediction activation control unit 19 determines whether or not the activation of one call control server 20 can cover the number of calls that increases after S seconds. When R is less than or equal to M (No in Step S208), the prediction activation control unit 19 determines that the calls whose number increases after S seconds can be processed by the one activated call control server 20, and thus ends the process of the activation determination of the call control server 20.

On the other hand, when R is larger than M (Yes in Step S208), the prediction activation control unit 19 determines whether or not there is the suspended call control server 20 (Step S209). When there is no suspended call control server 20 (No in Step S209), the prediction activation control unit 19 ends the process of the activation determination of the call control server 20.

On the other hand, when there is the suspended call control server 20 (Yes in Step S209), the prediction activation control unit 19 activates one of the suspended call control servers 20 (Step S210).

Subsequently, the prediction activation control unit 19 uses as R, a value obtained by subtracting the maximum connection number (M) from R, i.e., R−M (Step S211) and returns to Step S208.

Here, in the above description, the prediction activation control unit 19 selects the call control server 20 to be activated from among the transfer source servers which are transferring the calling process to the call control servers 20 in which the sum of the increase of the number of outgoing calls and the increase of the number of communicating calls after S seconds exceeds the remaining resource; however, the prediction activation control unit 19 is not limited thereto. For example, the prediction activation control unit 19 may appropriately select one of the suspended call control servers 20 and activate the selected server, and transfer the calling process having transferred from the other call control server 20 to the call control server 20 in which the sum of the increase of the number of outgoing calls and the increase of the number of communicating calls after S seconds exceeds the remaining resource.

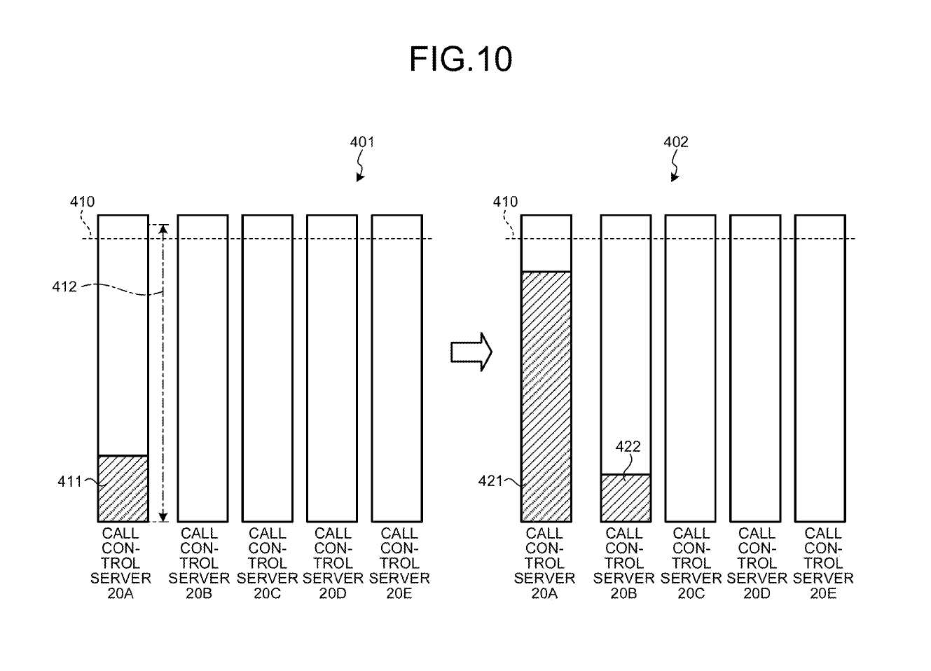

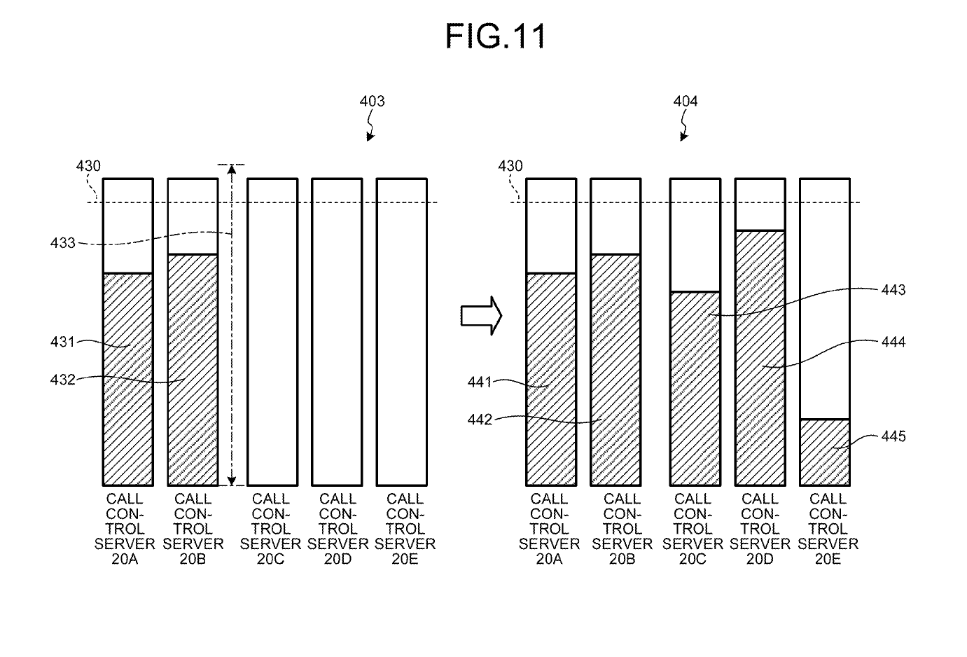

Next, description is made of the transition of the number of calls for each call control server 20 in the case where the calling process has been transferred by the communication control device 1 according to this embodiment with reference to FIG. 10 and FIG. 11. FIG. 10 is a diagram illustrating an example of the transition of the number of calls in the case where one call control server is activated based on the prediction of the increase of the number of calls. FIG. 11 is a diagram illustrating an example of the transition of the number of calls in the case where a plurality of call control servers is activated based on the prediction of the increase of the number of calls. Here, description is made of the case where there are five call control servers 20, which are referred to as call control servers 20A to 20E, respectively. In each of FIG. 10 and FIG. 11, bar graphs correspond to the call control servers 20A to 20E, and a portion having oblique lines in the bar graph represents the number of calls to be processed by each of the call control servers 20A to 20E.

A state 401 of FIG. 10 indicates a state where the call control server 20A is in operation and the other four call control servers 20B to 20E are suspended. The number of calls 411 is the number of calls to be processed by the call control server 20A in operation. Then, the maximum connection number 410 represents the maximum connection number of each of the call control servers 20A to 20E, and a call loss is caused when the number of calls exceeds a line of the maximum connection number 410.

Here, the number of calls 412 is the predicted number of calls to be processed by the call control server 20A after S seconds from the state 401 that is obtained by the communication control device 1. In this case, the number of calls 412 exceeds the maximum connection number 410.

Thus, the communication control device 1 activates the suspended call control server 20B. Then, the calling process that has been transferred to the call control server 20A is returned to the activated call control server 20B.

This produces a state 402 after S seconds. That is, the number of calls to be processed by the call control server 20A becomes the number of calls 421. Moreover, the number of calls to be processed by the call control server 20B becomes the number of calls 422. Then, neither the number of calls 421 nor the number of calls 422 exceeds the maximum connection number 410.

Therefore, the communication control device 1 can suppress the occurrence of the call loss by causing the state of the call control servers 20A to 20E transit to the state 402.

Moreover, a state 403 of FIG. 11 indicates a state in which the call control servers 20A and 20B are in operation and the other three call control servers 20C to 20E are suspended. The number of calls 431 is the number of calls to be processed by the call control server 20A in operation. Moreover, the number of calls 432 is the number of calls to be processed by the call control server 20B in operation. Then, the maximum connection number 430 represents the maximum connection number of each of the call control servers 20A to 20E, and the call loss is caused when the number of calls exceeds the line of the maximum connection number 430.

Here, the number of calls 433 is the number of calls of the call control servers 20A and 20B after S seconds from the state 403 obtained by the communication control device 1. In FIG. 11, the number of calls 433 is represented in a manner of protruding outside the bar graph. This indicates that the number of calls 433 is far exceeding the maximum connection number 430. That is, in this case, the number of calls to be processed by the call control servers 20A and 20B far exceeds the maximum connection number 430.

In view of this, the communication control device 1 activates the suspended call control servers 20C to 20E. Here, when only the call control server 20C is activated, the number of calls to be processed by the call control servers 20A and 20B exceeds the maximum connection number 430; therefore, the communication control device 1 activates the three call control servers 20C to 20E. Then, the calling process that has been transferred to the call control server 20A or 20B is returned to the activated call control servers 20C to 20E.

This produces a state 404 after S seconds. That is, the number of calls to be processed by the call control server 20A becomes the number of calls 441. Moreover, the number of calls to be processed by the call control server 20B becomes the number of calls 442. Moreover, the number of calls to be processed by the call control server 20C becomes the number of calls 443. Moreover, the number of calls to be processed by the call control server 20D becomes the number of calls 444. Moreover, the number of calls to be processed by the call control server 20E becomes the number of calls 445. Then, none of the numbers of calls 441 to 445 exceeds the maximum connection number 430.

Therefore, the communication control device 1 can suppress the occurrence of the call loss by causing the state of the call control servers 20A to 20E to transit to the state 404.

As described above, the communication control device according to this embodiment obtains the increase of the number of calls of the call control servers after a predetermined period of time by using the outgoing call speed and the communicating call speed, which are the increase rate of the number of calls for each call control server, and the outgoing call acceleration and the communicating call acceleration, which is the change rate of the increase rate of the number of calls. The communication control device according to this embodiment then determines whether or not to activate the suspended call control server by using the obtained increase of the number of calls. This makes it possible to perform the prediction of the increase of the number of calls with high accuracy and to suppress the occurrence of the call loss.

Therefore, the appropriate activation of the call control server for suppressing the occurrence of the call loss can be performed in such a state that the call control server is suspended in order to suppress the power consumption of the communication system, thereby reducing the call loss while suppressing the power consumption of the communication system.

### Modified Embodiment

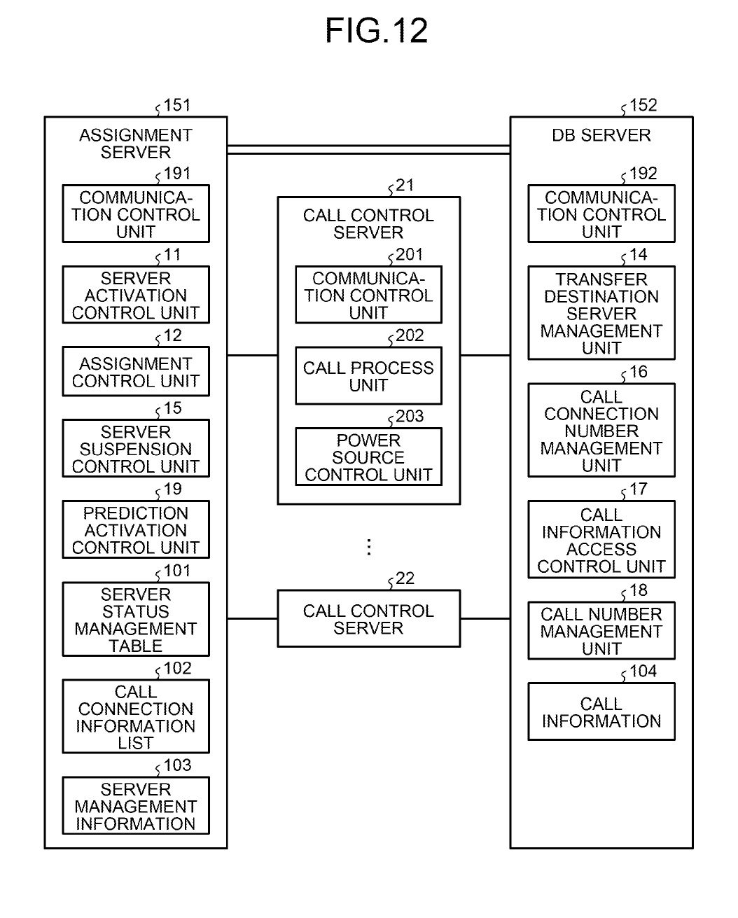

Next, a modified embodiment of the first embodiment is described. A communication control system according to this modified embodiment is different from that of the first embodiment in that a communication control device is structured by two servers. Thus, a communication control system in the case in which a communication control device 1 is structured by being divided into an assignment server 151 and a DB (Data Base) server 152 is described with reference to FIG. 12. FIG. 12 is a diagram of the structure example in the case in which the communication control device is structured by two servers.

The assignment server 151 has a server activation control unit 11, an assignment control unit 12, a server suspension control unit 15, a prediction activation control unit 19, and a communication control unit 191. Moreover, the assignment server 151 stores a server status management table 101, a call connection information list 102, and server management information 103. The assignment server 151 is a server having a function of assigning a calling process to call control servers 20.

The DB server 152 has a transfer destination server management unit 14, a call connection number management unit 16, a call information access control unit 17, a call number management unit 18, and a communication control unit 192. Moreover, the DB server 152 stores call information 104. The DB server 152 is a server having a function of managing a database with which the call information is registered.

Then, in FIG. 12, units denoted by the same reference symbols as those of FIG. 1 have the same function. Since the device is divided into two servers, however, the communication control unit 13 in FIG. 1 is divided into the communication control unit 191 in the assignment server 151 and the communication control unit 192 in the DB server 152. When the units arranged in the assignment server 151 and the units arranged in the DB server 152 communicate with each other, the communication is performed via the communication control unit 191 and the communication control unit 192.

Thus, the communication control device 1 can be divided into the two servers as illustrated in FIG. 12 or the functions thereof can be divided into two or more servers. Moreover, a way of dividing the functions is not limited to the example of FIG. 12, and there is no particular limitation on which server may have which function.

### Second Embodiment

Next, a communication control device according to a second embodiment is described. The communication control device according to this embodiment is different from that of the first embodiment in that when the increase of the number of calls is larger in a current time than in a previous time, a period of monitoring the increase of the number of times is shortened. Moreover, the communication control device according to this embodiment is different from that of the first embodiment in that when the increase of the number of calls is larger in the current time than in the previous time, a call control server is suspended.

The communication control device of this embodiment is also represented in FIG. 1. Description of units having the same function as that of the first embodiment is omitted below.

A prediction activation control unit 19 obtains the increases of the number of outgoing calls and the number of communicating calls after S seconds in a manner similar to the first embodiment.

Next, the prediction activation control unit 19 decides whether or not to activate a suspended call control server 20 depending on whether or not the sum of the increases of the number of outgoing calls and the number of communicating calls after S seconds is larger than a remaining resource, and activates the call control server 20 according to the decision in a manner similar to the first embodiment.

When the sum of the increases of the number of outgoing calls and the number of communicating calls after S seconds is smaller than the remaining resource, next, the prediction activation control unit 19 determines whether or not current outgoing call acceleration is larger than previous outgoing call acceleration. When the current outgoing call acceleration is larger than the previous one, the prediction activation control unit 19 shortens a period T of monitoring the increase of the number of calls. For example, the prediction activation control unit 19 halves the period T.

Moreover, the prediction activation control unit 19 activates one of the suspended call control servers 20. For example, the prediction activation control unit 19 selects and activates one of the call control servers 20 from which a calling process has been transferred to the call control server 20 in which the number of processed calls is the largest. Then, the prediction activation control unit 19 returns the transferred calling process to the activated call control server 20.

On the other hand, when the current outgoing call acceleration is smaller than the previous one, the prediction activation control unit 19 determines whether or not current communicating call acceleration is larger than previous communicating call acceleration. When the current communicating call acceleration is larger than the previous one, the prediction activation control unit 19 shortens the period T of monitoring the increase of the number of calls. For example, the prediction activation control unit 19 halves the period T.

Moreover, the prediction activation control unit 19 activates one of the suspended call control servers 20. For example, the prediction activation control unit 19 selects and activates one of the call control servers 20 from which the calling process has been transferred to the call control server 20 in which the number of processed calls is the largest. The prediction activation control unit 19 then returns the transferred calling process to the activated call control server 20.

In the case of activating the call control server 20 as a result of comparing the outgoing call acceleration or the communicating call acceleration, the sum of the increases of the number of outgoing calls and the number of communicating calls after S seconds is smaller than the remaining resource; therefore, a call loss can be suppressed by activating one call control server 20.

Moreover, in such a state that the monitor period is made shorter than an initial value, the prediction activation control unit 19 returns the monitor period to the initial value in any of the case where the current outgoing call acceleration is smaller than the previous one and the case where the current communicating call acceleration is smaller than the previous one.

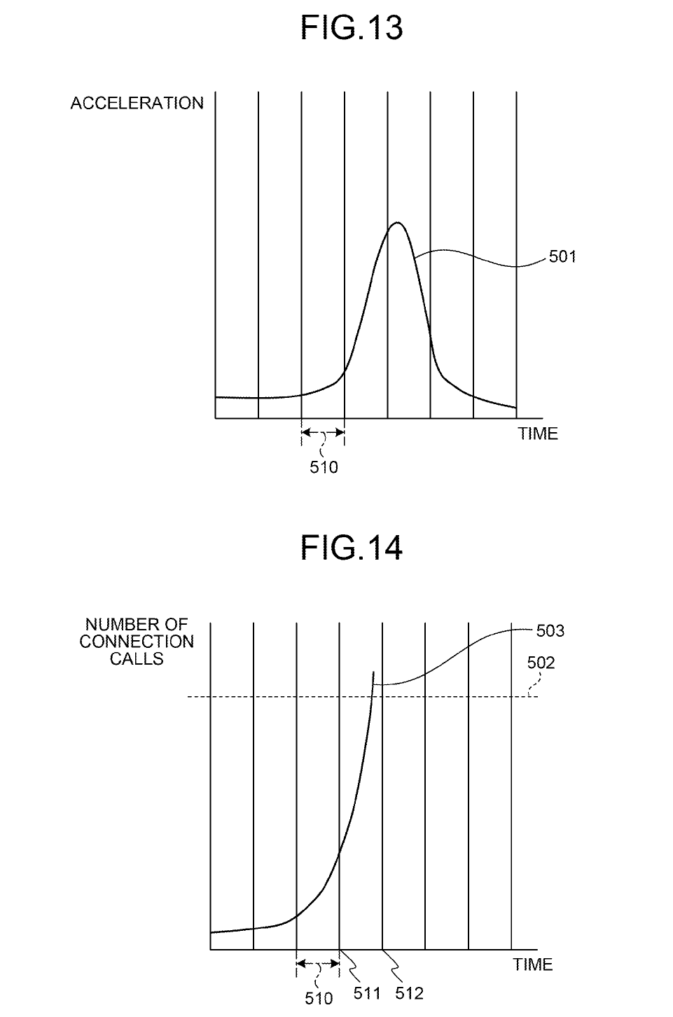

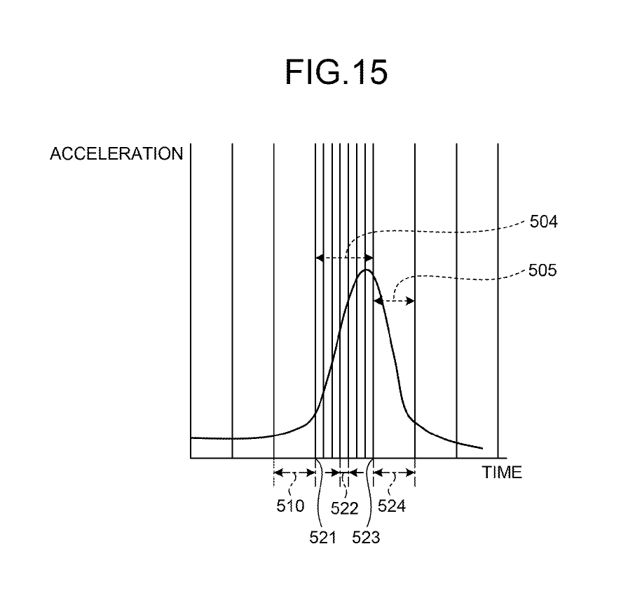

Here, description is made of an effect of shortening the monitor period when the outgoing call acceleration and the communicating call acceleration is greater than the previous ones with reference to FIG. 13 to FIG. 15. FIG. 13 is a diagram representing an example of the relation between the change in the outgoing call acceleration and a constant monitor period. FIG. 14 is a diagram representing an example of the relation between the number of connections and the monitor period. FIG. 15 is a diagram representing an example of the relation between the change in the outgoing call acceleration and the change in the monitor period. Here, description is made by using the outgoing call acceleration, but the matters similarly apply to the communicating call acceleration.

The vertical axis of FIG. 13 represents the outgoing call acceleration and the horizontal axis thereof represents time. Then, lines parallel to the vertical axis represent timing of monitoring the number of outgoing calls, and a period 510 is the monitor period. In FIG. 13, the monitor is being performed for the period 510. The outgoing call acceleration then changes as in a graph 501. In this case, even when the acceleration has suddenly risen, the monitor is performed after the elapse of the period 510.

Then, when the outgoing call acceleration has changed as in the graph 501, the number of connections may transit as in a graph 503 of FIG. 14. The vertical axis of FIG. 14 represents the number of connection calls and the horizontal axis represents time. Then, in FIG. 14, lines parallel to the vertical axis represent timing of monitoring the number of outgoing calls and the period 510 is the monitor period. In this case, since the outgoing call acceleration is not so large at a timing 511, it can be considered that the prediction activation control unit 19 determines that the increase after S seconds does not exceed the remaining resource. However, the acceleration suddenly rises subsequently; therefore, the graph 503 may exceed the maximum connection number 502 before the next monitor timing 512.

Then, as illustrated in FIG. 15, the current outgoing call acceleration becomes larger than the previous outgoing call acceleration at a timing 521 in such a state that the monitor is being performed for the period 510, which is the initial value of the monitor period; therefore, the prediction activation control unit 19 shortens the monitor period to a period 522. Thus, even though the number of connections has suddenly increased due to the increase in the outgoing call acceleration in a period of time 504, the communication control device 1 can activate the suspended call control server 20 before the maximum connection number is exceeded, due to the monitor for the period 522. Then, the current outgoing call acceleration becomes smaller than the previous outgoing call acceleration at a timing 523 in such a state that the monitor is being performed for the period 522, which is the initial value of the monitor period; therefore, the prediction activation control unit 19 returns the monitor period to the same period as the period 510 as with a period 524. Since the outgoing call acceleration is decreased in a period of time 505, the increase of the number of calls does not suddenly rise; therefore, it is unlikely that the number of calls processed by the call control server 20 exceeds the maximum connection number during the monitor period even when the period is set to the period 524.

In this manner, the communication control device 1 can suppress the call loss by changing the period in accordance with the change in the outgoing call acceleration and the communicating call acceleration.

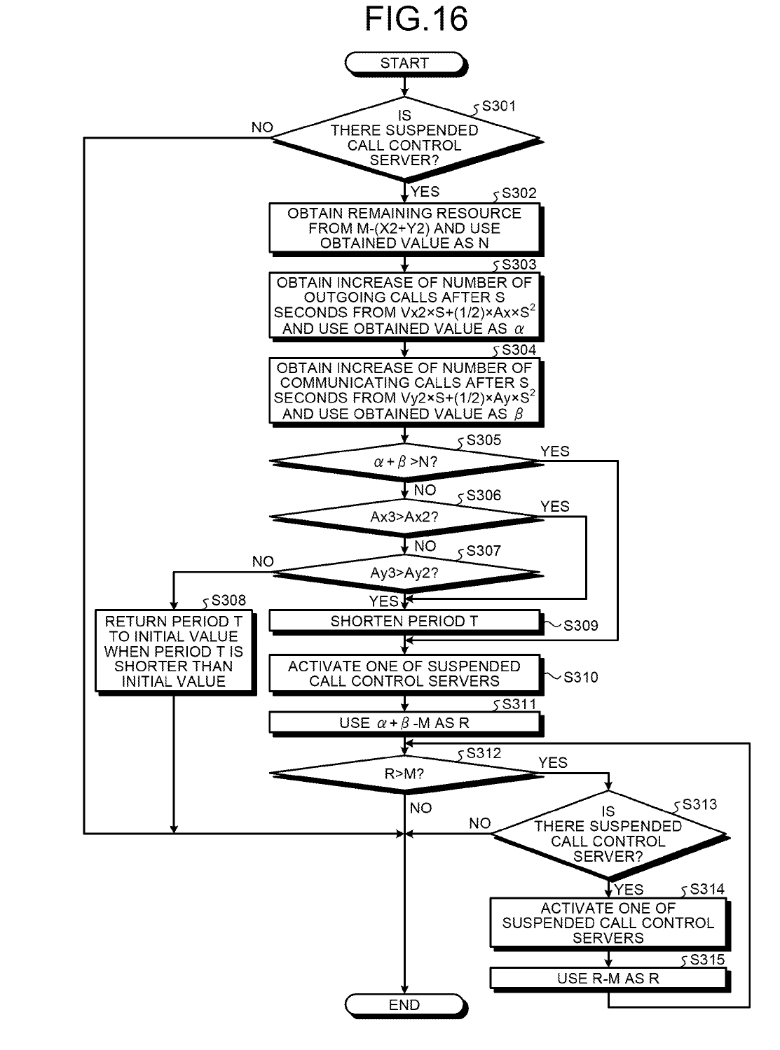

Next, activation determination of the call control server 20 by the communication control device 1 according to this embodiment is described with reference to FIG. 16. FIG. 16 is a flowchart of a process of the activation determination of the call control server by the communication control device according to the second embodiment.

The prediction activation control unit 19 determines whether or not there is the suspended call control server 20 (Step S301). In this embodiment, the prediction activation control unit 19 determines whether or not there is the suspended call control server 20 in the transfer source servers from which the calling process is being transferred to the call control server 20 in which the sum of the increases of the number of outgoing calls and the number of communicating calls exceeds the remaining resource. When there is no suspended call control server 20 (No in Step S301), the prediction activation control unit 19 ends the process of the activation determination of the call control server 20.

On the other hand, when there is the suspended call control server 20 (Yes in Step S301), the prediction activation control unit 19 obtains the remaining resource by using the maximum connection number (M) of the call control server 20, the current number of outgoing calls (X2), and the current number of communicating calls (Y2) in a formula of M−(X2+Y2). Then, the prediction activation control unit 19 uses the obtained remaining resource as N (Step S302).

Next, the prediction activation control unit 19 obtains the increase of the number of outgoing calls after S seconds by using a current outgoing call speed (Vx2), a server operation time (S), and an average value of the outgoing call acceleration (Ax)in a formula of Vx2×S+(½)×Ax×S². Then, the prediction activation control unit 19 uses the obtained increase of the number of outgoing calls as a (Step S303).

Moreover, the prediction activation control unit 19 obtains the increase of the number of communicating calls after S seconds by using a current communicating call speed (Vy2), the server operation time (S), and an average value of the communicating call acceleration (Ay) in a formula of Vy2×S+(½)×Ay×S². Then, the prediction activation control unit 19 uses the obtained increase of the number of communicating calls as 13 (Step S304).

Next, the prediction activation control unit 19 determines whether or not α+β, which is the sum of the increase of the number of outgoing calls and the increase of the number of communicating calls after S seconds, is larger than N, which is the remaining resource (Step S305). When α+β is larger than N (Yes in Step S305), the prediction activation control unit 19 proceeds to Step S310.

On the other hand, when α+β is less than or equal to N (No in Step S305), the prediction activation control unit 19 determines whether or not the current outgoing call acceleration (Ax3) is larger than the previous outgoing call acceleration (Ax2) (Step S306). When the current outgoing call acceleration (Ax3) is larger than the previous outgoing call acceleration (Ax2) (Yes in Step S306), the prediction activation control unit 19 proceeds to Step S309.

On the other hand, when the current outgoing call acceleration (Ax3) is less than or equal to the previous outgoing call acceleration (Ax2) (No in Step S306), the prediction activation control unit 19 determines whether or not the current communicating call acceleration (Ay3) is larger than the previous communicating call acceleration (Ay2) (Step S307). When the current communicating call acceleration (Ay3) is less than or equal to the previous communicating call acceleration (Ay2) (No in Step S307) and the current period T is shorter than the initial value, the prediction activation control unit 19 returns the period T to the initial value (Step S308). Then, the prediction activation control unit 19 ends the process of the activation determination of the call control server 20.

On the other hand, when the current communicating call acceleration (Ay3) is larger than the previous communicating call acceleration (Ay2) (Yes in Step S307), the prediction activation control unit 19 shortens the period T (Step S309).

Next, the prediction activation control unit 19 activates one of the suspended call control servers 20 (Step S310).

Next, the prediction activation control unit 19 uses as R, a value obtained by subtracting the maximum connection number from the sum of the increase of the number of outgoing calls and the increase of the number of communicating calls after S seconds, i.e., α+β−M (Step S311).

Next, the prediction activation control unit 19 determines whether or not R is larger than the maximum connection number (M) (Step S312). In other words, the prediction activation control unit 19 determines whether or not the activation of one call control server 20 can cover the number of calls that increases after S seconds. When R is less than or equal to M (No in Step S312), the prediction activation control unit 19 determines that the calls whose number increases after S seconds can be processed by the one activated call control server 20, and thus ends the process of the activation determination of the call control server 20.

On the other hand, when R is larger than M (Yes in Step S312), the prediction activation control unit 19 determines whether or not there is the suspended call control server 20 (Step S313). When there is no suspended call control server (No in Step S313), the prediction activation control unit 19 ends the process of the activation determination of the call control server 20.

On the other hand, when there is the suspended call control server 20 (Yes in Step S313), the prediction activation control unit 19 activates one of the suspended call control servers 20 (Step S314).

Subsequently, the prediction activation control unit 19 uses as R, a value obtained by subtracting the maximum connection number (M) from R, i.e., R−M (Step S315), and returns to Step S312.

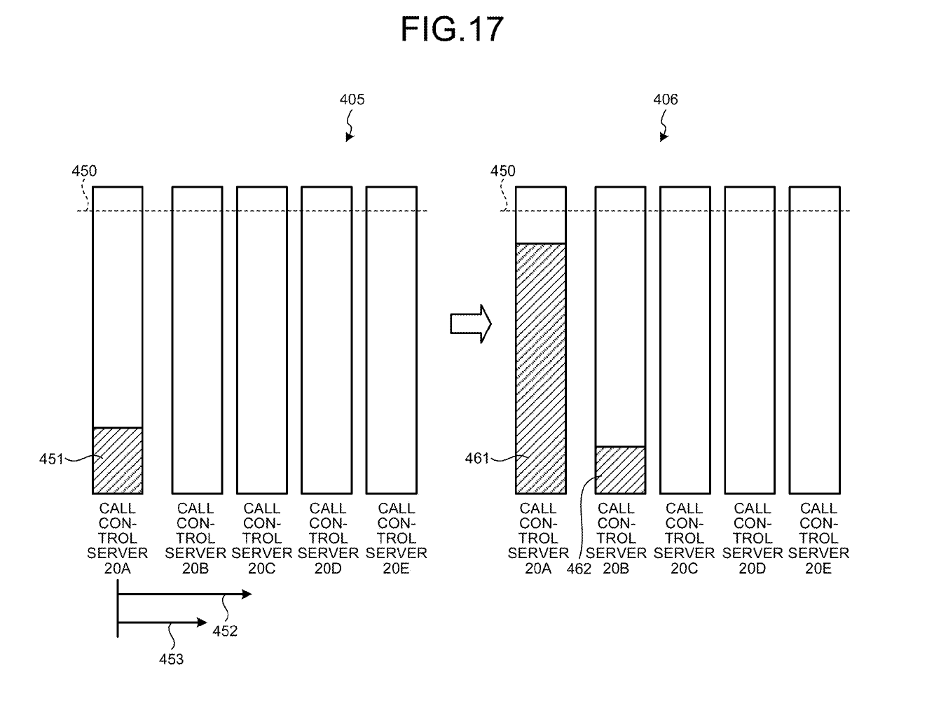

Next, description is made of the transition of the number of calls for each call control server 20 in the case where the calling process has been transferred by the communication control device 1 according to this embodiment with reference to FIG. 17. FIG. 17 is a diagram illustrating an example of the transition of the number of calls in the case where one call control server is activated based on the outgoing call acceleration. Here, the case of five call control servers 20 is described and the servers are referred to as call control servers 20A to 20E, respectively. In FIG. 17, the bar graphs correspond to the call control servers 20A to 20E, and a portion having oblique lines in the bar graph represents the number of calls to be processed by each of the call control servers 20A to 20E. Here, the outgoing call acceleration is described as an example, but the matters similarly apply to the communicating call acceleration.

A state 405 represents a state in which the call control server 20A is in operation and the other four call control servers 20B to 20E are suspended. The number of calls 451 is the number of calls to be processed by the call control server 20A in operation. Then, the maximum connection number 450 represents the maximum connection number of each of the call control servers 20A to 20E, and when the number of calls exceeds a line of the maximum connection number 450, the call loss occurs.

Here, acceleration 452 is the current outgoing call acceleration and acceleration 453 is the previous outgoing call acceleration. In this case, the acceleration 452 is larger than the acceleration 453.

Thus, the communication control device 1 activates the suspended call control server 20B. Then, the calling process that has been transferred to the call control server 20A is returned to the activated call control server 20B.

This produces a state 406 after S seconds. In other words, the number of calls to be processed by the call control server 20A becomes the number of calls 461. Moreover, the number of calls to be processed by the call control server 20B becomes the number of calls 462. Then, neither the number of calls 461 nor the number of calls 462 exceeds the maximum connection number 450.

Therefore, by causing the state of the call control servers 20A to 20E to transit to the state 406, the communication control device 1 can suppress the call loss.

The communication control device according to this embodiment shortens the period of monitoring the increase of the number of calls and activates one of the call control servers when the outgoing call acceleration or the communicating call acceleration has increased from the previous one. This can suppress the occurrence of the call loss due to the sudden increase in the number of calls.

Moreover, the communication control device according to this embodiment returns the period of monitoring the increase of the number of calls to the initial value when the outgoing call acceleration or the communicating call acceleration has decreased from the previous one. This can reduce a load on the communication control device.

Here, although the description has been made of the processes of shortening the period and suspending the server based on the increase and decrease in the outgoing call acceleration or the communicating call acceleration in the second embodiment above, any one of the above processes may be performed. For example, it is possible to deal with the sudden increase in the number of calls just by shortening the period based on the increase and decrease in the outgoing call acceleration and the communicating call acceleration. Moreover, it is possible to deal with the sudden increase in the number of calls just by suspending one call control server based on the increase and decrease in the outgoing call acceleration and the communicating call acceleration. Further, it may be unnecessary to return the period after the period is shortened, and the shortened period may be returned upon the reception of an instruction from an operator. Moreover, the processes of shortening the period and suspending the server may be performed based on the increase and decrease in any one of the outgoing call acceleration and the communicating call acceleration.

Further, the functions of the communication control device according to the second embodiment may be divided into a plurality of devices in a manner similar to the modified example of the first embodiment.

Hardware Structure

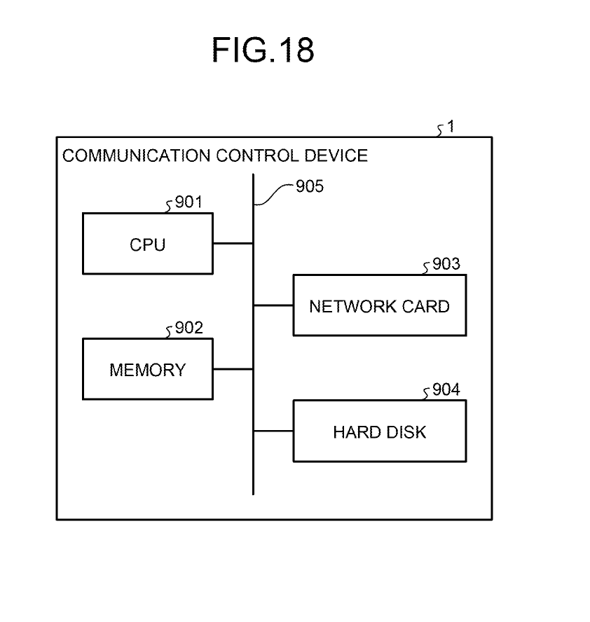

Next, a hardware structure of the communication control device 1 according to each of the above embodiments is described. FIG. 18 is a diagram illustrating an example of the hardware structure of the communication control device.

As illustrated in FIG. 18, the communication control device 1 has a CPU (Central Processing Unit) 901, a memory 902, a network card 903, and a hard disk 904.

The memory 902, the network card 903, and the hard disk 904 are connected to each other through the CPU 901 and a bus 905.

The network card 903 has a communication interface between the network card 903 and an external device. The network card 903 realizes the function of the communication control unit 13 illustrated in FIG. 1, for example.

The hard disk 904 realizes the function of the storage unit 10. In other words, in the hard disk 904, the server status management table 101, the call connection information list 102, the server management information 103, and the call information 104 illustrated in FIG. 1 are stored. Moreover, the hard disk 904 stores various programs including programs that realize the functions of the server activation control unit 11, the assignment control unit 12, the transfer destination server management unit 14, and the server suspension control unit 15 illustrated in FIG. 1. Furthermore, the hard disk 904 stores various programs including programs that realize the functions of the call connection number management unit 16, the call information access control unit 17, the call number management unit 18, and the prediction activation control unit 19 illustrated in FIG. 1.

The CPU 901 and the memory 902 realize the functions of the server activation control unit 11, the assignment control unit 12, the transfer destination server management unit 14, and the server suspension control unit 15 illustrated in FIG. 1. Further, the CPU 901 and the memory 902 realize the functions of the call connection number management unit 16, the call information access control unit 17, the call number management unit 18, and the prediction activation control unit 19 illustrated in FIG. 1. Specifically, the CPU 901 reads in various programs from the hard disk 904 and develops a process on the memory 902. Then, the CPU 901 realizes the functions of the server activation control unit 11, the assignment control unit 12, the transfer destination server management unit 14, and the server suspension control unit 15 by executing the process developed on the memory 902. Moreover, the CPU 901 realizes the functions of the call connection number management unit 16, the call information access control unit 17, the call number management unit 18, and the prediction activation control unit 19 by executing the process developed on the memory 902.

According to one aspect of a communication control device, a communication control method, and a communication control system disclosed in the present application, an effect is obtained that can reduce a call loss while suppressing the power consumption of a communication system.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A communication control device comprising:
a call connection number management unit that acquires a call connection number representing a number of calls being processed by each call control server performing a calling process;
a server suspension control unit that selects a first call control server from the call control servers based on the call connection number for each of the call control servers, transfers the calling process allocated to the first call control server to other call control server, and suspends the first call control server when the calling process allocated to the first call control server no longer exists;
an assignment control unit that accepts a process request related to the calling process, and when the call control server that has performed the calling process responding to the process request is suspended by the server suspension control unit, assigns the process request to the other call control server to which the server suspension control unit has transferred the calling process responding to the process request; and
a prediction activation control unit that calculates a change rate of an increase rate of number of calls to be processed by a particular call control server, obtains a prediction value of a number of calls to be processed by the particular call control server after a predetermined period of time on the basis of the change rate, and when the prediction value is exceeding a predetermined value, activates a suspended call control server.

2. The communication control device according to claim 1, further comprising a server activation control unit that stores a server activation threshold in advance and when a load of any of the call control servers has exceeded the server activation threshold, activates the suspended call control server.

3. The communication control device according to claim 1, wherein the prediction activation control unit periodically obtains the change rate of the increase rate of the number of calls to be processed by the particular call control server, and when the change rate obtained in a current period of the increase rate of the number of calls to be processed by the particular call control server is larger than the change rate obtained in a previous period of the increase rate of the number of calls to be processed by the particular call control server, activates the suspended call control server.

4. The communication control device according to claim 1, wherein the prediction activation control unit periodically obtains the change rate of the increase rate of the number of calls to be processed by the particular call control server, and when the change rate obtained in the current period of the increase rate of the number of calls to be processed by the particular call control server is larger than the change rate obtained in the previous period of the increase rate of the number of calls to be processed by the particular call control server, shortens the period.

5. The communication control device according to claim 1, wherein the prediction activation control unit extends the period when the change rate obtained in the current period of the increase rate of the number of calls to be processed by the particular call control server is smaller than the change rate obtained in the previous period of the increase rate of the number of calls to be processed by the particular call control server and when the period is shortened.

6. A communication control method comprising:
acquiring a call connection number representing a number of calls being processed by each call control server performing a calling process;
selecting a first call control server from the call control servers based on the call connection number for each of the call control servers and transferring the calling process allocated to the first call control server to other call control server;
suspending the first call control server when the calling process allocated to the first call control server no longer exists;
accepting a process request related to the calling process, and when the call control server that has performed the calling process responding to the process request is suspended, assigning the process request to the other call control server to which the calling process responding to the process request has been transferred;
calculating a change rate of an increase rate of number of calls to be processed by a particular call control server;
obtaining a prediction value of a number of calls to be processed by the particular call control server after a predetermined period of time on the basis of the change rate; and
activating a suspended call control server when the prediction value is exceeding a predetermined value.

7. A communication control system having a call control server and a communication control device, wherein:
the call control server includes
a call process unit that performs a calling process and
a suspension control unit that suspends the call control server; and
the communication control device includes
a call connection number management unit that acquires a call connection number representing a number of calls being processed by each call control server,
a server suspension control unit that selects a first call control server from the call control servers based on the call connection number for each of the call control servers, transfers the calling process allocated to the first call control server to other call control server, and instructs the first call control server to suspend the first call control server when the calling process allocated to the first call control server no longer exists,
an assignment control unit that accepts a process request related to the calling process, and when the call control server that has performed the calling process responding to the process request is suspended, assigns the process request to the other call control server to which the server suspension control unit has transferred the calling process responding to the process request, and
a prediction activation control unit that calculates a change rate of an increase rate of number of calls to be processed by a particular call control server, obtains a prediction value of a number of calls to be processed by the particular call control server after a predetermined period of time on the basis of the change rate, and when the prediction value is exceeding a predetermined value, activates a suspended call control server.
